(19) United States
(12) Patent Application Publication
(10) Pub. No.: US 2026/0341261 A1
(43) Pub. Date: Oct. 29, 2026

(54) CONVERSATION CONTENT INJECTION USING ARTIFICIAL INTELLIGENCE

(71) Applicant: The Toronto-Dominion Bank, Toronto (CA)

(72) Inventors: Alexandre Dionne, Toronto (CA); Daniel Chan, Toronto (CA); Daniel Chammas, Toronto (CA); Danika Babin-Demers, Toronto (CA); Xuan Qin, Toronto (CA); Ian Wong, Toronto (CA); Alexandre Guertin, Toronto (CA); Debora Santelli, Toronto (CA); Xavier Dubé, Toronto (CA); Simranjit Warraich, Toronto (CA); Rajendra Dharaj, Toronto (CA); Myriam Benzaquen-Lasry, Toronto (CA); Mehran Moghtadai, Toronto (CA)

(73) Assignee: The Toronto-Dominion Bank, Toronto (CA)

(21) Appl. No.: 19/186,777

(22) Filed: Apr. 23, 2025

(51) Int. Cl. G10L 13/00; G10L 25/78

(52) U.S. Cl. CPC G10L 13/00; G10L 25/78

(57) ABSTRACT

An example operation may include at least one of capturing, by a software application, speech data from a conversation as it occurs during a communication session conducted via the software application between a first device and a second device, detecting, by the software application, a pause in the conversation based on the speech data captured from the conversation, prioritizing, by the software application, a portion of the speech data that occurs within a predetermined time interval of the pause in the conversation, generating, by the software application, conversation content based on execution of an artificial intelligence (AI) model on the prioritized portion of the speech data, and outputting, by the software application, the conversation content during the communication session based on the pause in the conversation. The example operation may further include an AI agent performing an action related to the outputting of the conversation content.

### BACKGROUND

Communication software for managing inbound and outbound calls such as those that can occur between devices, at a contact center, at public safety access point (PSAP), and the like, provide technology that enables participants of a call to communicate over a public telephone network. Meanwhile, artificial intelligence is a technology that enables computers (and machines) to simulate human behavior and even perform activities that may exceed what humans are capable of performing.

### SUMMARY

One example embodiment provides an apparatus that may include a memory, and at least one processor communicatively coupled to the memory, where the at least one processor may capture, by a software application, speech data from a conversation as it occurs during a communication session conducted via the software application between a first device and a second device, detect, by the software application, a pause in the conversation based on the speech data captured from the conversation, prioritize, by the software application, a portion of the speech data that occurs within a predetermined time interval of the pause in the conversation, generate conversation content by the software application based on execution of an artificial intelligence (AI) model on the speech data including the portion of the speech data that is prioritized, and output, by the software application, the conversation content during the communication session based on the pause in the conversation.

Another example embodiment provides a method that includes at least one of capturing, by a software application, speech data from a conversation as it occurs during a communication session conducted via the software application between a first device and a second device, detecting, by the software application, a pause in the conversation based on the speech data captured from the conversation, prioritizing, by the software application, a portion of the speech data that occurs within a predetermined time interval of the pause in the conversation, generating, by the software application, conversation content based on execution of an artificial intelligence (AI) model on the prioritized portion of the speech data, and outputting, by the software application, the conversation content during the communication session based on the pause in the conversation.

A further example embodiment provides a computer-readable medium comprising instructions, that when read by a processor, cause the processor to perform at least one of capturing, by a software application, speech data from a conversation as it occurs during a communication session conducted via the software application between a first device and a second device, detecting, by the software application, a pause in the conversation based on the speech data captured from the conversation, prioritizing, by the software application, a portion of the speech data that occurs within a predetermined time interval of the pause in the conversation, generating, by the software application, conversation content based on execution of an artificial intelligence (AI) model on the prioritized portion of the speech data, and outputting, by the software application, the conversation content during the communication session based on the pause in the conversation.

### BRIEF DESCRIPTION OF THE DRAWINGS

FIG. 1A is a diagram illustrating an operating environment of a software service, according to examples and features of the instant solution.

FIG. 1B is a diagram illustrating a computing environment for generating and injecting conversation content into a communication session using artificial intelligence according to examples and features of the instant solution.

FIG. 2A is a system diagram illustrating integration of an AI model into any decision point, according to the examples and features of the instant solution.

FIG. 2B is a diagram illustrating a process for developing an AI model that supports AI-assisted computer decision points, according to the examples and features of the instant solution.

FIG. 2C is a diagram illustrating a process for utilizing an AI model that supports AI-assisted computer decision points according to examples and features of the instant solution.

FIG. 3 is a system diagram illustrating an operating environment for a communication service according to the examples and features of the instant solution.

FIGS. 4A-4C are diagrams illustrating a process of detecting a pause in a conversation and outputting conversation content during the pause according to the examples and features of the instant solution.

FIG. 5A is a diagram illustrating a process of analyzing audio from a communication session according to the examples and features of the instant solution.

FIG. 5B is a diagram illustrating a process of executing at least one AI model to generate conversation content according to the examples and features of the instant solution.

FIGS. 6A-6C are diagrams illustrating a process of identifying an available pixel location on a display screen and outputting conversation content at the available pixel location according to the examples and features of the instant solution.

FIGS. 7A and 7B are diagrams illustrating a process of receiving feedback conversation content generated by the at least one AI model and retraining the at least one AI model based on the feedback according to the examples and features of the instant solution.

FIG. 8A is a diagram illustrating a method of generating and injecting conversation content into an ongoing communication session according to the examples and features of the instant solution.

FIG. 8B is a diagram illustrating another method of generating and injecting conversation content into an ongoing communication session according to the examples and features of the instant solution.

FIG. 9 is a diagram illustrating a computing system that may be used in any of the examples and features of the instant solution described herein.

### DETAILED DESCRIPTION

It is to be understood that although this disclosure includes a detailed description of cloud computing, implementation of the instant solution recited herein is not limited to a cloud computing environment. Rather, features of the instant solution are capable of being implemented in conjunction with any other type of computing environment now known or later developed.

The examples and features of the instant solution are directed to a system that can listen to a conversation being conducted between users of different communication devices (e.g., phones, tablets, computers, etc.) and dynamically inject conversation content into the conversation. For example, the conversation content may include content that may be spoken by at least one of the users participating in the conversation. According to various examples and features of the instant solution, the system may leverage one or more artificial intelligence (AI) models to determine whether to inject content, to dynamically generate the content, and to determine when to inject the content into the conversation of the communication session.

According to various examples and features of the instant solution, the system may identify a pause in the conversation, for example, utilizing speech data from the conversation and audio processing performed by the system. In response to detecting the occurrence of the pause, the system may generate conversation content to continue the conversation without significant delay. For example, the system may execute the at least one AI model on conversation content from the communication session up until the point that the pause occurs and determine content to be spoken by one of the users during the conversation. In some examples and features of the instant solution, the AI model may prioritize (eg., apply a greater weight) to speech data that occurs closer in time to the pause (e.g., the last 30 seconds, 60 seconds, 90 seconds, etc.) before the pause.

The at least one AI model may populate a graphical user interface (GUI) of a software being used to conduct the communication session with the generated content. The at least one AI model may also generate a tone in which the conversation content may be spoken, or the like. Prior to sending the conversation content to the user, the system may verify whether the content violates a policy, rule, law, etc. which prevents certain types of sensitive data from being exposed.

In some examples and features of the instant solution, the software that may be used to perform the communication session may include a back-end that may be hosted by a host platform, such as a cloud platform, a web server, a distributed system, or the like. The software may also include a front-end that may be installed or otherwise running on a device participating in the communication session. The back-end of the software may be used to perform audio processing on the speech data and detect the occurrence of the pause in the communication session. Meanwhile, the front-end of the software may execute the at least one AI model to generate the content that may be injected into the communication session.

Some of the technical benefits provided by the system herein includes the bi-furcation of tasks between the front-end and the back-end of the software. By performing audio processing with a back-end of the software application and performing AI tasks with the front-end of the software application, the system may speed-up the processing to generate and output the conversation content at the right time within the conversation in comparison to performing the tasks with the back-end or the front-end of the software. A technical benefit of the examples and features of the instant solution may determine when to inject content within a conversation using audio processing software. The software can detect a pause in the conversation and trigger the A l model to create conversation content to overcome the pause in the conversation.

Furthermore, the system is able to detect when a person speaking within a teleconference is struggling with a particular topic, for example, based on a pause in the conversation. The system is then able to take over the conversation for the user and provide spoken output/chat output into the conversation in an automated manner. The conversation may be about any kind of subject matter such as a personal discussion, a business discussion, a financial discussion, an insurance discussion, and the like. The system can detect the topics to be discussed, for example, from a call script, and may detect when a topic that have has not been discussed or has not been discussed fully, and output content about the topic not fully discussed.

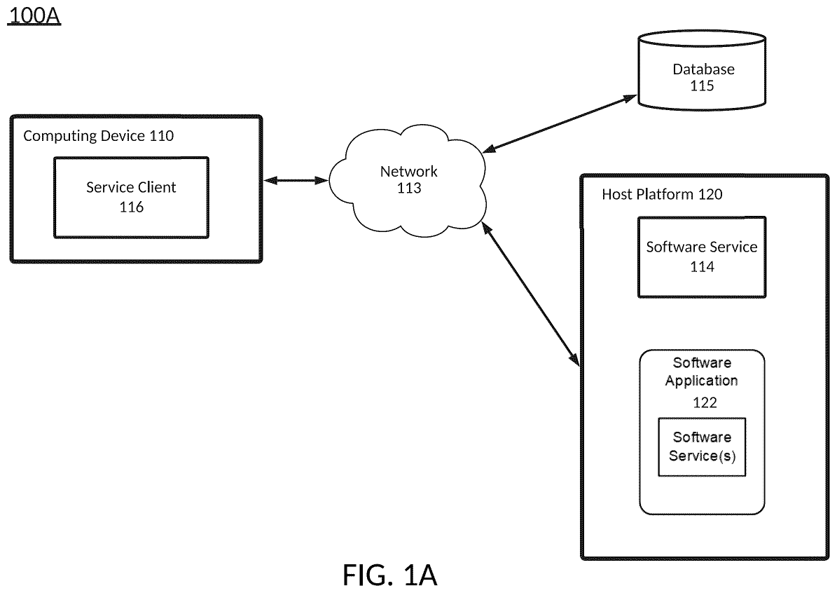

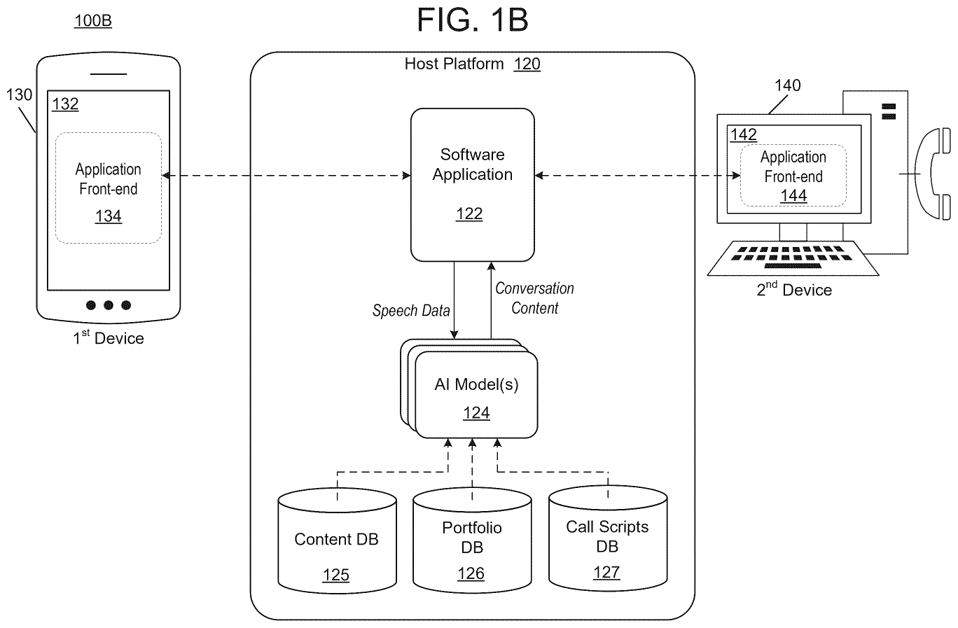

FIG. 1A is a system diagram illustrating an example operating environment of the instant solution. As shown, at least one computing device 110, and a host platform 120 communicate via a network 113. The host platform 120 may host a software service 114, a software application 122 containing at least one software service, and the like. The software service 114 and/or the software application 122 may communicate with at least one database 115 through a network 113 during the course of service execution. A computing device 110 may host a service client 116, which communicates with a corresponding software service 114.

A computing device 110 may be a mobile phone, tablet, laptop computer, desktop computer, smartwatch, vehicle infotainment system, or any computing device including a processor and memory. The host platform 120 may include a single physical server, multiple physical servers, a cloud hosting environment, or a hybrid hosting environment in which some components of the host platform 120 are “on-premise” while others are cloud-hosted. The network 113 may be a computer network and may include at least one interconnected computer network. For example, network 113 may be or may include an Ethernet network, an asynchronous transfer mode (ATM) network, a wireless network, a telecommunications network or the like.

The software service 114 provides the service logic. It may provide at least one Application Programming Interface (API) for communicating with at least one service client 116. A “thick” user interface client that runs on a computing device 110 may utilize the A Pls to communicate with the software service 114. Further, the software service 114 may provide hosted User Interfaces (UIs) that can be accessed through browser-based software on some computing devices 110.

The software application 122 may include at least one service (eg., at least one software service 114, etc.) For example, the software application 122 may include or otherwise be made up of a plurality of services that are independently managed with separate A Pls.

The at least one service client 116 can enable service access for end users and may come in a variety of forms including, but not limited to, a mobile device application (“app”) or a web portal accessed via a browser on a computing device 110 such as a laptop or desktop computer.

FIG. 1B illustrates a computing environment for generating and injecting conversation content into a communication session using artificial intelligence according to examples and features of the instant solution. Referring to FIG. 1B, the host platform 120, such as a cloud platform, web server, etc., may host a communication session, such as a meeting, between a first device 130 and a second device 140 through a software application 122. The host platform 120 may connect to the first device 130 and the second 140 over a computer network such as a cellular network, the Internet, a private network, and the like.

According to various examples and features of the instant solution, the first device 130 and the second device 140 may be at least one of a mobile device, a computer, a laptop, a desktop computer, a contact center access point, and the like. The first device 130 and the second device 140 may display conversation content from the conversation including text, images, and the like, and play audio (eg., spoken by a user, spoken by a talking bot, etc.) from the conversation which can be output via speakers (not shown). For example, the first device 130 may also include a microphone (not shown) for capturing audio spoken by a user thereof which may then be transferred to the second device 140 via the software application 122. Likewise, the second device 140 may include a microphone (not shown) for capturing audio spoken by a user thereof.

Here, the host platform 120 may host the software application 122 and make it accessible to the first device 130 and the second device 140 at the same time over a computer network such as the Internet. Thus, the first device 130 and the second device 140 may connect for a communication session via the software application 122. For example, the software application 122 may be a mobile application that includes a front-end which may be installed on the first device 130 (and the second device 140) and a back-end which may be installed on the host platform 120. The software application 122 may be a progressive web application (PWA) that may be hosted by the host platform 120 and made accessible via a browser on the first device 130 and/or the second device 140 via an address on the web. The first device 130 and the second device 140 may display a graphical user interface (GUI) output by the software application 122, for example, an application front-end 134 GUI that may be shown on a display device 132 of the first device 130 and an application front-end 144 GUI that may be shown on a display device 142 of the second device 140.

In the examples and features of the instant solution, the host platform 120 may include one or more artificial intelligence (AI) models including at least one AI model 124 which may be capable of ingesting speech data, visual data, audio, etc. from conversation content during a live conversation and dynamically generate additional conversation content that can be displayed on one or more of the application front-end 134 and the application front-end 144, spoken during the communication session (e.g., by a talking bot) and the like. In some examples and features of the instant solution, the at least one AI model 124 may be trained on one or more of historical topics of conversation content within a data store such as content DB 125, user portfolio data stored in a data store such as portfolio DB 126, call transcripts stored in a data store such as call scripts DB 127, and the like. The host platform 120 may also include one or more additional models including one or more machine learning models, one or more AI models, and the like. The models including the at least one AI model 124 may be held by the host platform 120 within a model repository (not shown).

In the example of FIG. 1B, the first device 130 and the second device 140 may exchange speech, text, images, and the like, communications submitted through the software application 122. For example, audio may be spoken, text may be entered into a text box, documents may be viewed, and the like. The conversation between the users may be recorded by the software application 122, converted into a vector or other encoding, and submitted to the at least one AI model 124. In response, the at least one AI model 124 may dynamically detect topics that are being discussed during the meeting from the conversation content and dynamically generate GUI content to be displayed during the meeting or audio content to be spoken.

In some examples and features of the instant solution, the conversation content that may be displayed during the communication session may include content that may be visible to the first device 130 and the second device 140 and/or content that may be visible to one of the devices. The software application 122 may control which device sees which content and create different experiences on the application front-ends of the first device 130 and the second device 140 during the communication session. Furthermore, the at least one AI model 124 may ingest speech data from the communication session and generate additional content that can be displayed and or spoken during the conversation and additional content that can be used after the communication session such as a call script, a call list, a link, and the like. The at least one AI model 124 may use audio with speech data from the conversation to detect when the conversation changes from one topic to another and modify the generated content or generate additional content in response to such a change.

Referring to FIG. 1B, the first device 130 and the second device 140 may be examples of the computing device 110 (see, for example, FIG. 1A). The software application 122 may be an example of software service 114 (see, for example, FIG. 1A). The content DB 125, portfolio DB, and call scripts DB may be examples of database 115 (see, for example, FIG. 1A). The application front-end 134 and application front-end 144 may be examples of service client 116 (see, for example, FIG. 1A).

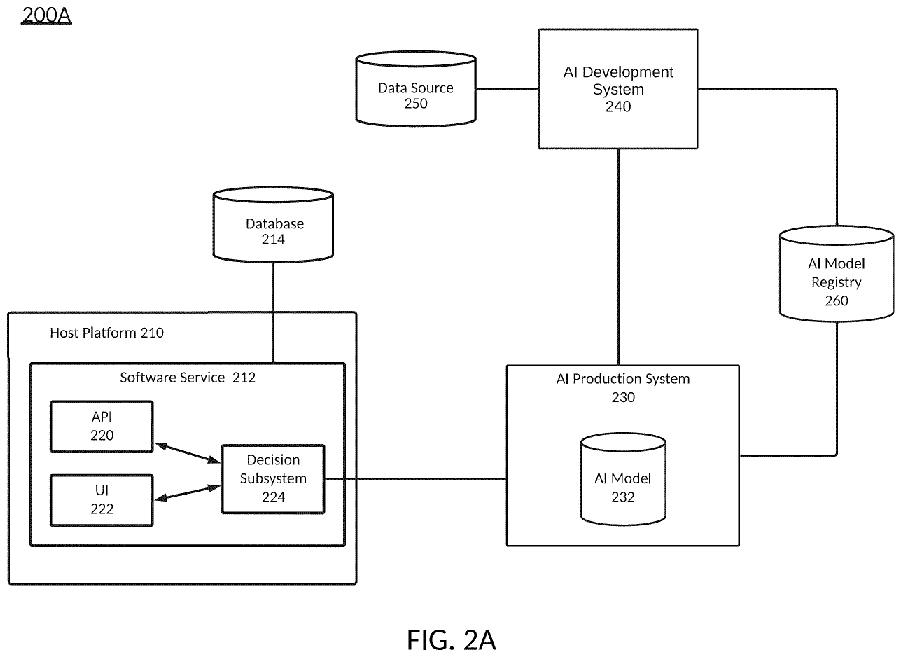

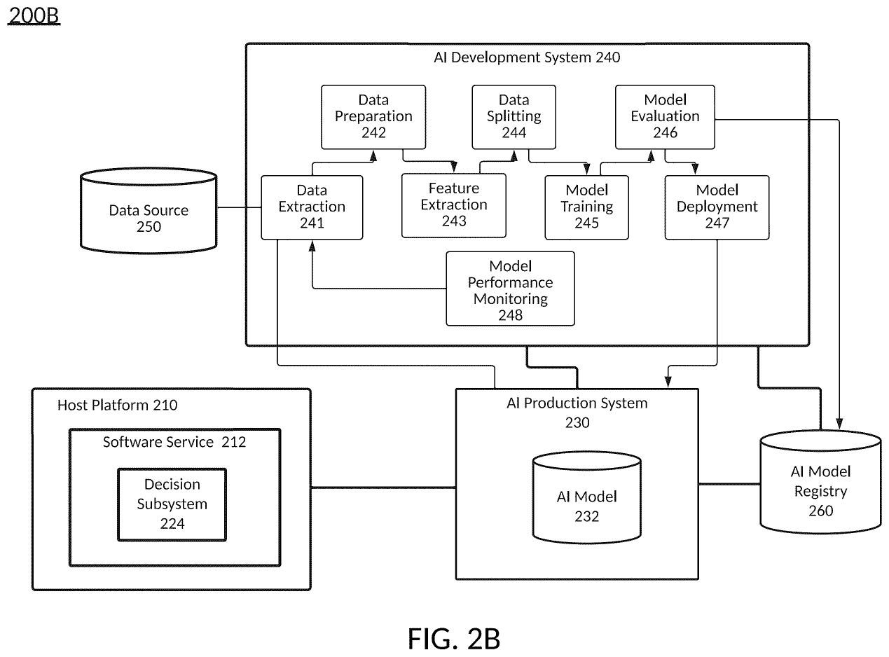

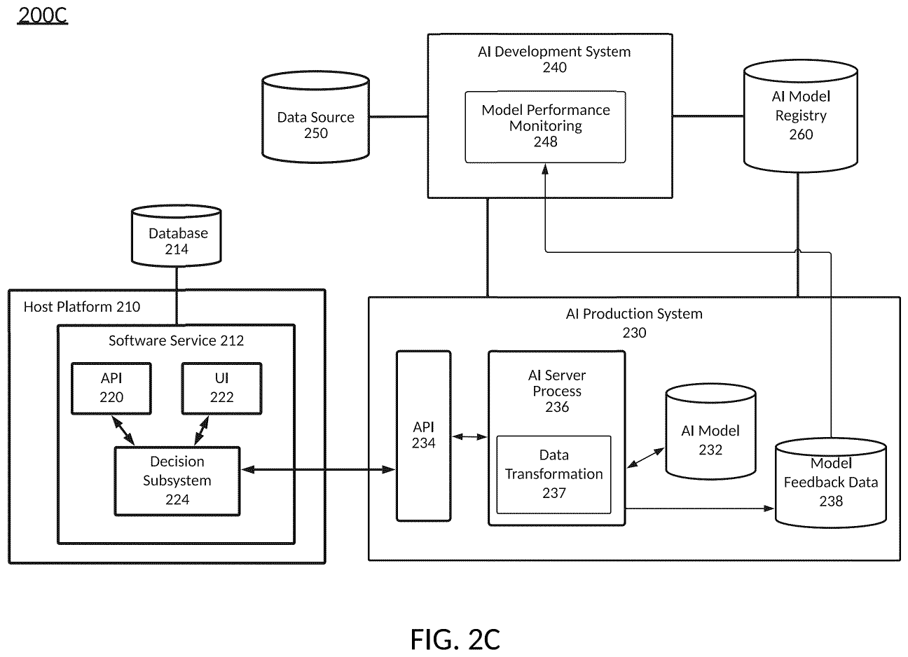

FIG. 2A illustrates an AI network diagram 200A that supports AI-assisted decision points in a software service executing on a computer. While the example instant solution shown utilizes a neural network, which is a type of machine learning (M L) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, M L models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, increasing its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 212 (see FIGS. 1A, 2A) , executing on host platform 210 (see FIGS. 1A and 2A) may provide at least one A PI 220 that enable interaction with other software components via a set of data definitions and protocols. In some examples and features of the instant solution, the at least one API provided may employ Simple Object Access Protocol (SOAP), Remote Procedure Calls (RPC), and Representational State Transfer (REST) techniques. In some examples and features of the instant solution, the plurality of APIs 220 send data to at least one decision subsystem 224 of the software service 212 to assist in decision-making. In some examples and features of the instant solution, the software service 212 stores data included in A PI requests or data generated during processing the A PI requests into at least one database 214 (see FIGS. 1A, 2A).

Software service 212 may provide at least one user interface (UI) 222, such as a server-side hosted graphical user interface (GUI). In some examples and features of the instant solution, the UIs 222 provided employ template-based frameworks, component-based frameworks, etc. In some examples and features of the instant solution, these UIs 222 send data to at least one decision subsystem 224 of the software service 212 to assist with decision-making. In some examples and features of the instant solution, the software service 212 stores data included in UI requests or data generated during processing the UI requests into at least one database 214.

Software service 212 may include at least one decision subsystem 224 that drive a decision-making process of the software service 212. In some examples and features of the instant solution, the decision subsystems 224 receive data from at least one A PI 220 as input into the decision-making process. In some examples and features of the instant solution, a decision subsystem 224 may receive data from at least one UI 222 as input to the decision-making process. A decision subsystem 224 may gather service configuration or historical execution data from at least one database 214 to aid in the decision-making process. A decision subsystem 224 may provide feedback to an A PI 220 or a UI 222.

An AI production system 230 may be used by a decision subsystem 224 in a software service 212 to assist in its decision-making process. The AI production system 230 includes at least one AI model 232 that may be executed to generate a response, such as, but not limited to, a prediction, a categorization, a UI prompt, etc. In some examples and features of the instant solution, an AI production system 230 may be hosted on a server. In some examples and features of the instant solution, the AI production system 230 may be cloud-hosted. In some examples and features of the instant solution, the AI production system 230 may be deployed in a distributed multi-node architecture.

An AI development system 240 creates at least one AI model 232. In some examples and features of the instant solution, the AI development system 240 utilizes data from at least one data source 250 to develop and train at least one AI model 232. The data sources 250 may be local or third-party data sources. Further, the data provided by the data sources may be real-world or synthetic. In some examples and features of the instant solution, the AI development system 240 utilizes feedback data from at least one AI production system 230 for new model development and/or existing model re-training. In some examples and features of the instant solution, the AI development system 240 resides and executes on a server. In some examples and features of the instant solution, the AI development system 240 may be cloud hosted. In some examples and features of the instant solution, the AI development system 240 may be deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by at least one AI production system 230. The AI model registry 260 resides in a dedicated server in one example of the instant solution. In some examples and features of the instant solution, the AI model registry 260 may be cloud-hosted. In some examples and features of the instant solution, the AI model registry 260 resides in the AI production system 230. In some examples and features of the instant solution, the AI model registry 260 may be a distributed database.

FIG. 2B illustrates a process 200B for developing at least one AI model that support AI-assisted decision points. An AI development system 240 executes steps to develop an AI model 232 that begins with data extraction 241, in which data may be loaded and ingested from at least one data source 250. In some examples and features of the instant solution, historical model feedback data may be extracted from at least one AI production system 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to at least one data transformation being employed to normalize at least one value in the dataset. In some examples and features of the instant solution, data deemed to be noisy may be cleaned. A noisy dataset includes values that do not contribute to the training, such as, but not limited to, null and long string values. Data preparation 242 may be a manual process or an automated process using at least one of the elements and/or functions described and/or depicted herein.

Features of the data are identified and extracted during the feature extraction step 243. In some examples and features of the instant solution, a feature of the data may be internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using at least one of the elements and/or functions described and/or depicted herein. Once the features have been identified, the values of the features are collected into a dataset that will be used to develop the AI model 232.

The dataset output from the feature extraction step 243 may be split 244 into a training and validation data set. The training data set may be used to train the AI model 232, and the validation data set may be used to evaluate the performance of the AI model 232 on unseen data.

The AI model 232 may be trained and tuned 245 using the training data set from the data splitting step 244. In this step, the training data set may be provided to an AI algorithm and an initial set of algorithm parameters. The performance of the A I model 232 may then be tested within the AI development system 240 utilizing the validation data set from step 244. These steps may be repeated with adjustments to at least one algorithm parameter until the model's performance may be acceptable based on various goals and/or results.

The AI model 232 may be evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 may be used. In some examples and features of the instant solution, at least one unseen validation dataset may be used. In some examples and features of the instant solution, the staging environment may be part of the AI development system 240, and the staging environment may be managed separately from the AI development system 240. Once the AI model 232 has been validated, it may be stored in an AI model registry 260, where it can be retrieved for deployment and future updates. In some examples and features of the instant solution, the model evaluation step 246 may be a manual process or an automated process using at least one of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to at least one AI production system 230. In some examples and features of the instant solution, the performance of deployed AI model 232 may be monitored 248 by the AI development system 240. In some examples and features of the instant solution, AI model 232 feedback data may be provided by the AI production system 230 to enable model performance monitoring 248, and the AI development system 240 periodically requests feedback data for model performance monitoring 248, which includes at least one trigger that results in the AI model 232 being updated by repeating steps 241-248 with updated data from at least one data source 250.

FIG. 2C illustrates a process 200C for utilizing an AI model that supports AI-assisted decision points. As stated previously, the AI model utilization process depicted herein reflects M L, which is a particular branch of AI, but this instant solution is not limited to M L and is not limited to any AI algorithm or combination of algorithms.

Referring to FIG. 2C, an AI production system 230 may be used by a decision subsystem 224 in software service 212 to assist in its decision-making process. The AI production system 230 provides an A PI 234, executed by an A I server process 236 through which requests can be made. In some examples and features of the instant solution, a request may include an AI model 232 identifier to be executed based on the type of request. In some examples and features of the instant solution, a data payload (e.g., to be input to the AI model during execution) may be included in the request. The data payload may include A PI 220 data from software service 21,2 UI 222 data from software service 212 or data from other software service 212 subsystems (not shown).

Upon receiving the A PI 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which may be a decision subsystem 224 of software service 212. In some examples and features of the instant solution, the response may result in an update to a UI 222 in software service 212. In some examples and features of the instant solution, the response includes a request identifier that can be used later by the software service 212 to provide feedback on the performance of the AI model 232. In some examples and features of the instant solution, a model feedback record may be added into a model feedback data 238 by the AI server process 236.

In some examples and features of the instant solution, the A PI 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data may be streamed to the AI development system 240 or may be provided upon request. In some examples and features of the instant solution, the model feedback records in the model feedback data 238 are used as an input for retraining the AI model 232.

Model retraining involves repeating steps 241-246 using the current data in the data source 250 along with the model feedback data 238. In some examples and features of the instant solution, the AI model 232 may be retrained periodically as a matter business process in order to consider the latest data and/or retrained based on a trigger, such as, but not limited to, a recent model accuracy falling below a pre-determined threshold. In some examples and features of the instant solution, the model feedback data 238 may be used as an input to determine the recent model accuracy.

In some examples and features of the instant solution, the AI production system 230 includes a user interface (not shown). The user interface may be used to manage the production system infrastructure, the components of the production system 230-238, and the operation of the AI production system and its components.

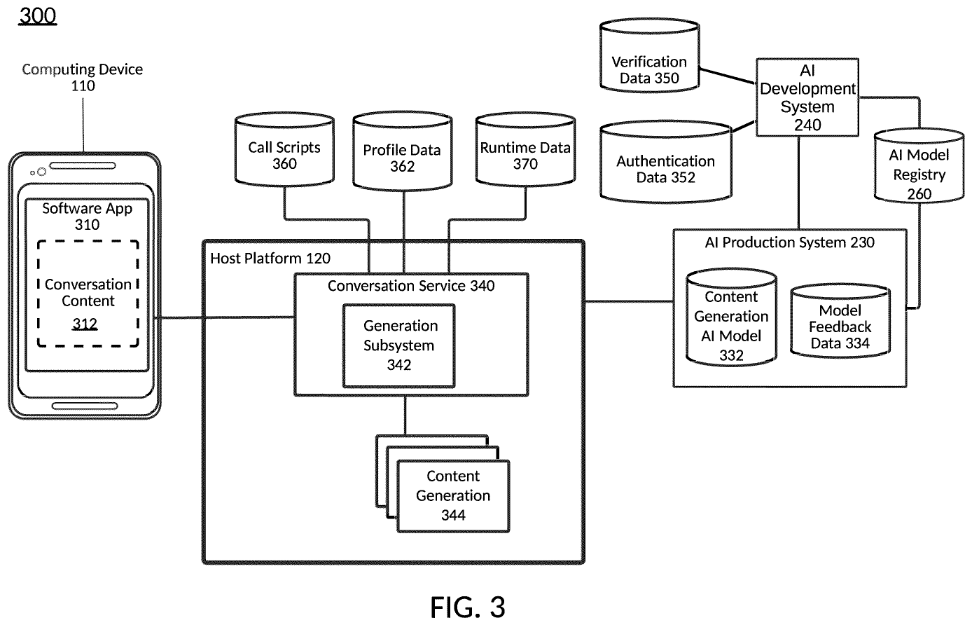

FIG. 3 illustrates an operating environment 300 for a communication service according to the examples and features of the instant solution. In some examples and features of the instant solution, a content generation AI model 332 may be trained using at least one of historical call scripts, historical profile data, runtime data including feedback, and the like, to generate conversation content that can be injected into a communication session given a set of feature data transformed from a set of application data and computing device data. The content generation AI model 332 may be an example of AI Model 232 (see, for example, FIGS. 2A-2C). The historical call scripts, historical profile data, runtime data including feedback may be examples of data source 250 (see, for example, FIGS. 2A-2C). The training of the content generation AI model 332 may be evaluated based on verification data 350, authentication data 352, and the like.

In some examples and features of the instant solution, the content generation AI model 332 may be trained using at least one neural network training method such as, but not limited to, gradient descent, stochastic gradient descent, random search, uniform search, basin hopping, and Krylov. In some examples and features of the instant solution, the content generation AI model 332 may be a single or multi-layer perceptron neural network, a feed-forward neural network, a radial basis functional neural network, a recurrent neural network, or a modular neural network.

In some examples and features of the instant solution, the content generation AI model 332 may include, but is not limited to, at least one of a machine learning model, a deep learning model, a neural network, any combination of models from the branches of AI, and the like, and it may be trained using at least one of the respective training methods for machine learning models, deep learning models, neural networks, any combination of models from the branches of AI, and the like. In some examples and features of the instant solution, the training data for the content generation AI model 332 may include, but is not limited to, internal data sources, external data sources, private data sources, public data sources, historical call scripts, historical profile data, runtime data including feedback, or the like.

In some examples and features of the instant solution, historical call scripts may include, but is not limited to, call scripts previously recorded between the same devices, different devices, and the like. The historical call scripts may include the utterances that are spoken, identifiers of which user spoke which utterances, timestamps of the utterances, and the like. The utterance may include a textual description of the audio from a historical video call, phone call, web call, meeting, or the like. The historical profile data may include profile data of the users that participated in the historical calls including which calls the users participated. The runtime data may include feedback that may be automatically captured by the software and/or that may be received from a GUI, etc.

The model feedback records in the model feedback data 334 may include, but is not limited to, inputs entered via a GUI which indicate whether the conversation content was spoken by one of the users, was good or bad, etc. The model feedback data 334 may include data that may be automatically detected by the software application. For example, the software application may verify whether or not suggested content may be spoken by one of the parties by capturing the audio from the communication session, converting it into text, and verifying that the conversation content may be included therein.

Once the content generation AI model 332 is trained and validated, it may be deployed to an AI production system 230 (see, for example, FIGS. 2A-2C, 3) for use by a conversation service 340. The conversation service 340 may be an example of software service 114 or software service 212 (see, for example, FIGS. 1A, 2A-2C).

In some examples and features of the instant solution, software app 310, running on computing device 110, may be an example of service client 116 (see FIG. 1A). The software app 310 may be a teleconferencing software application, a conferencing software application, a meeting software application, a contact center software application, a mobile application, or the like. The software app 310 may enable users to speak with one another over a network such as a cellular telephone network, the Internet, and the like. The software app 310 may also display content on a GUI of the software app 310, such as conversation content 312. The software app 310 may also display content generated by the content generation AI model 332.

In some examples and features of the instant solution, the conversation service 340 receives data from the software app 310. The data may include, but is not limited to, call scripts, images, text, audio, and the like.

Additionally, the conversation service 340 receives data about the computing device 110. The device data may include, but is not limited to, the media access control (MAC) address and the source internet protocol (IP) address of the computing device.

For example, the conversation service 340 may host a conversation between a first device and a second device. During the conversation, the conversation service 340 may instantiate a generation subsystem 342 which listens to the conversation (e.g., words, phrases, utterances, etc.) that are spoken during the conversation and determines whether or not to generate conversation content. When the generation subsystem 342 determines to generate conversation content, the generation subsystem 342 executes a process for content generation 344 which may invoke the content generation AI model 332 in the AI production system 230 for generative content that can be displayed, spoken, or the like, within the conversation. The invocation to the AI production system 230 may include speech data spoken within the conversation, call scripts, and the like. The content for the call may include data from a database of call scripts 360, a database of profile data 362, a database of runtime data 370, and the like, in addition to the speech data.

In response to receiving the invocation, the content generation AI model 332 may generate conversation content that may include at least one of an utterance, a phrase, a script, and the like, which can be output during the conversation. The conversation content may be provided to the conversation service 340 and output to a GUI of the software app 310, spoken by a talking bot via the software app 310, and the like.

According to various examples and features of the instant solution, the system described herein may detect a pause in a conversation that may be occurring during a communication session, generate conversation content to continue the conversation, and output the generated conversation content while the pause may be still occurring in the conversation.

Speech data may be captured by the software app 310 installed on the computing device 110. This data may be captured via a microphone on computing device 110. The captured speech data may be transmitted to the conversation service 340, which utilizes the content generation subsystem 342 to process the audio. Within this subsystem, an audio processor employs voice activity detection (VAD) to monitor the audio for silences by analyzing the audio signal's amplitude and energy levels over time to identify periods of inactivity. When the signal falls below a predefined energy threshold for a threshold period of time, it classifies these periods as conversational pauses. The generation subsystem 342 extracts and preprocesses a portion of the recent speech data leading up to the pause, emphasizing key phrases or unfinished statements for contextual relevance.

The preprocessed data may then be passed to the content generation A I model 332, residing in the AI production system 230. This AI model may be trained to recognize conversational nuances, such as natural interjections like, “Hmm” or “I see”, which it uses to generate fluid, contextually relevant conversational content. The AI model's attention mechanisms prioritize linguistic patterns, emotional tone, and intent derived from the recent segments of the conversation. For example, suppose the instant solution, which may fully or partially execute in a processor on the host platform 120 or any other processor mentioned herein, detects uncertainty in the speech preceding the pause. In that case, the AI model might generate a thoughtful response such as, “That's an interesting point,” to convey attentiveness.

The generated content may be delivered through the software app 310 and may be output as text displayed or as audio synthesized via text-to-speech functionality. Following the injection of the conversational content, the conversation service 340 monitors subsequent speech data to determine whether the injected content was acknowledged or used (e.g., feedback). The conversation service 340 monitors subsequent speech data captured during the communication session and compares it to the injected content stored in the database of runtime data 370. By analyzing whether the participants reference, respond to, or build upon the injected content, the system determines when the content was acknowledged or effectively used. This feedback, captured in the database of model feedback data 334, may be logged and sent back to the AI development system 240. The feedback may be utilized to retrain and refine the content Generation AI model 332 to improve its ability to predict conversational flow and adapt responses in future processing.

To achieve natural engagement, the content generation AI model 332 adapts its interjections based on the conversational context. For example, in professional settings, the AI model might use formal interjections like, “I understand,” while in casual settings, it might opt for informal ones like “Got it.” This contextual adaptability stems from the AI model's ability to analyze and learn from linguistic patterns and conversational nuances stored in the database of call scripts 360 and/or the database of profile data 362.

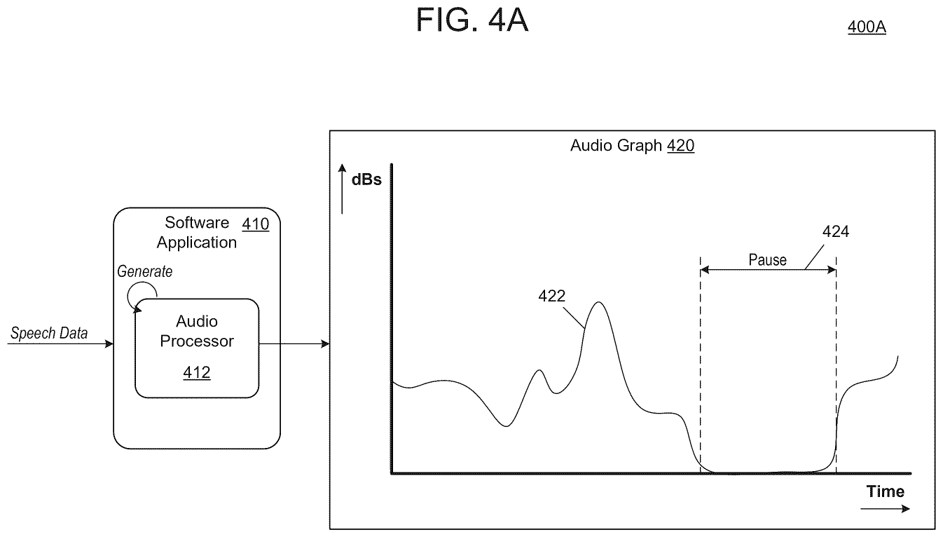

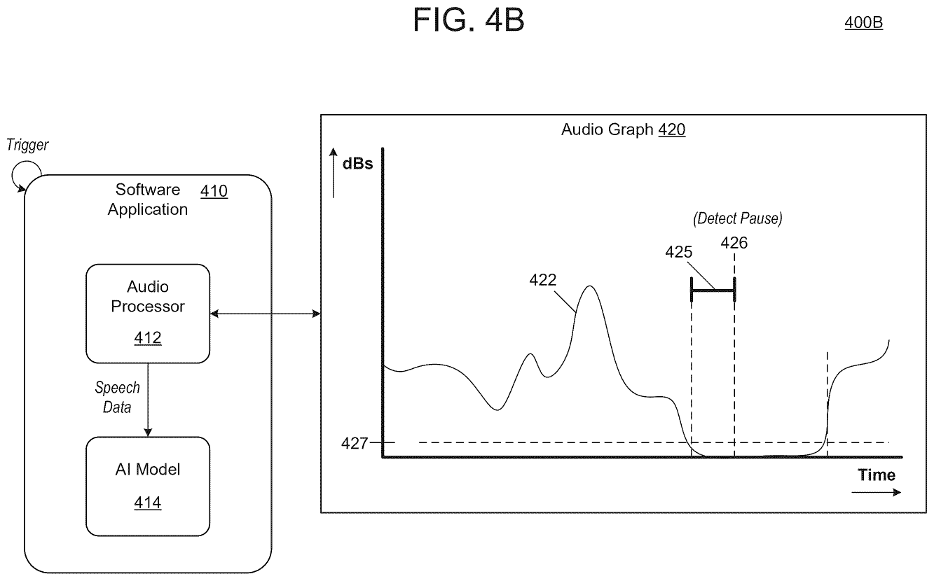

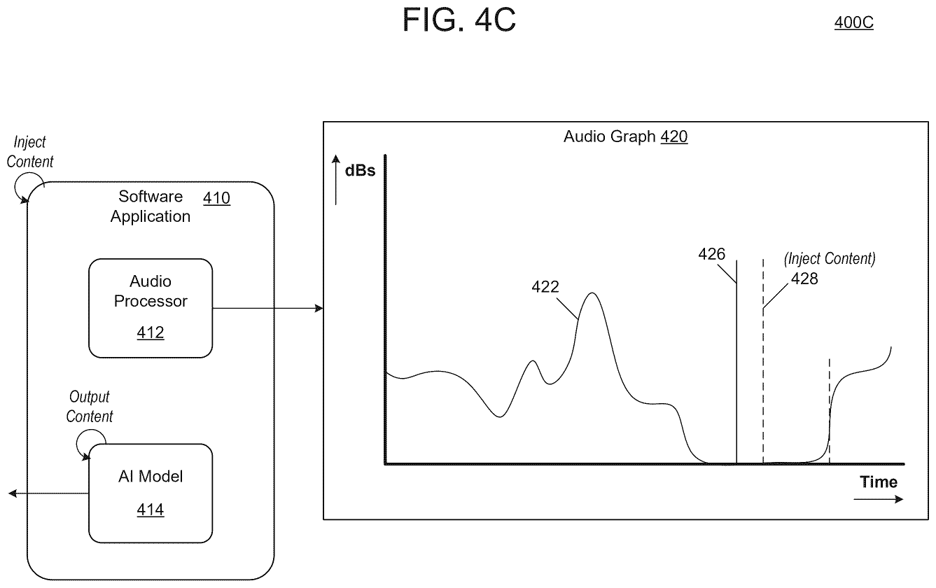

FIG. 4A illustrates a process 400A of converting audio from a communication session into an audio graph and analyzing the graph to identify an occurrence of a pause in the conversation content according to the examples and features of the instant solution. Referring to FIG. 4A, a software application 410 may be an example of a software service 114 or software service 212 (see, for example, FIGS. 1A, 2A-2C) and may host a communication session between a first device and a second device, which are not shown. The users of the devices may speak utterances during the communication session which can be captured by the software application 410 and input to an audio processor 412 of the software application 410. Here, the software may receive the audio from a microphone on one or more of the devices which converts the sound waves into audio signals. The sound waves may also be converted into a digital signal by an analog-to-digital converter (ADC) which allows the software to store and manipulate the audio data as digital data.

In this example, the audio processor 412 may convert the audio data into an audio graph 420 which can be analyzed for pauses. Here, the audio graph 420 includes a signal 422 (e.g., waveform) that represents an audio signal (e.g., speech, noise, etc.) that occurs during the communication session over time. The audio processor 412 may detect a pause 424 in the conversation content based on a threshold of the signal 422 over time. It should also be appreciated that the audio processor 412 may use a different mechanism or an additional mechanism in combination with the signal analysis to identify a pause in the conversation. For example, the audio processor 412 may analyze the sound level within the communication session by analyzing the sound energy over time using voice activity detection (VAD), zero-crossing rate, spectral energy, and the like.

When an amplitude of the signal drops below a predefined decibel (dB) level for at least a predefined threshold of time, the pause may be detected. For example, FIG. 4B illustrates a process 400B of detecting the pause at a point in time 426 in the signal 422 based on a predefined threshold 425 of time. Referring to FIG. 4B, the predefined threshold 425 may correspond to a minimum period of time (e.g., 2 seconds, 4 seconds, 10 seconds, etc.) where the audio signal may be below a predefined threshold energy level 427 in order for a pause to exist and be detected by the audio processor 412. In this example, the predefined threshold 425 may be used to measure the duration of time at which the energy level of the audio in the signal 422 may be below the predefined threshold energy level 427.

In response to detecting the pause at the point in time 426 in the signal 422, the audio processor 412 may forward audio content (eg., speech data which may include words, phrases, utterances, noises, etc.) from the conversation to an AI model 414. Here, the audio processor 412 may send the entire audio history from the conversation to the AI model 414. The audio processor 412 may send a most-recent amount of audio content (eg., the last 2 minutes, etc.) from the conversation to the AI model 414. In some examples and features of the instant solution, the audio processor 412 may identify a most-recent portion of the conversation (e.g., the last 20 seconds, the last 30 seconds, the last minute, etc.) In response the AI model 414 may weigh the most-recent portion of the conversation greater than other older parts of the conversation thereby giving more weight to that speech content when generating the conversation content. The AI model 414 may be an example of A I model 232 (see, for example, FIGS. 2A-2C).

FIG. 4C illustrates a process 400C of outputting generated audio content into an ongoing communication session according to the examples and features of the instant solution. Referring to FIG. 4C, the AI model 414 may be an example of AI model 232 (see, for example, FIGS. 2A-2C) and may generate conversation content (e.g., speech, audio, etc.) that may be output during the conversation currently occurring during the communication session. For example, the software application 410 may be an example of a software service 114 or software service 212 (see, for example, FIGS. 1A, 2A-2C) and may display the conversation content via a GUI of a device participating in the communication session. The software application 410 may use a talking bot to speak/utter the conversation content such that one or more of the devices can hear the conversation content, during the communication session.

In the example of FIG. 4C, the conversation content may be output at a point in time 428 after the point in time 426 at which the pause may be detected, but before the pause has ended. In other words, the system can output the conversation content during the pause. Prior to outputting the conversation content, the software application 410 may confirm/verify that the pause may still be occurring by processing additional speech data/audio data from the conversation being conducted during the ongoing communication session.

In some examples and features of the instant solution, the software application described herein may include a back-end that may be hosted by a remote platform, server, etc. and a front-end that may be installed or otherwise executed on a device participating in the communication session. The front-end of the software may include a GUI where content can be displayed.

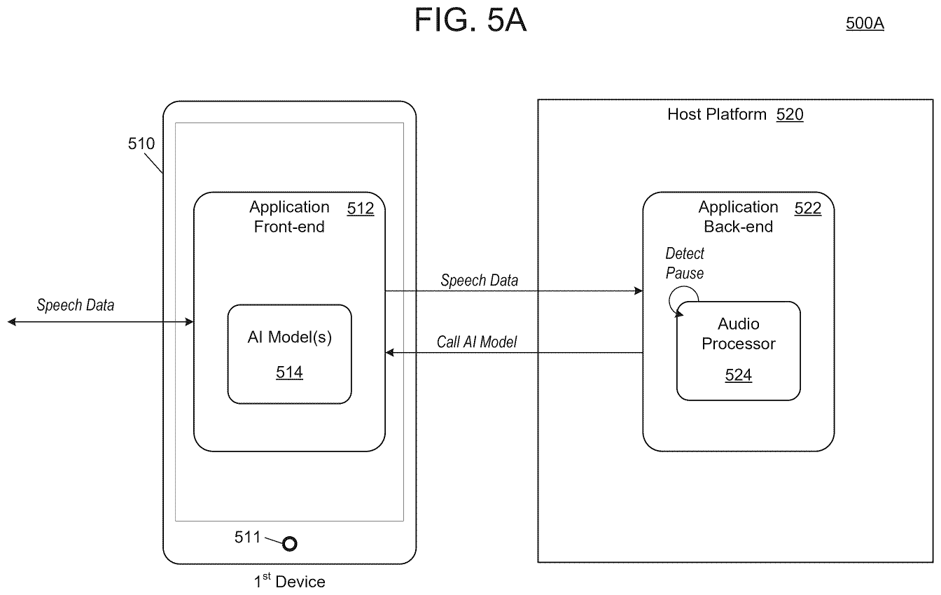

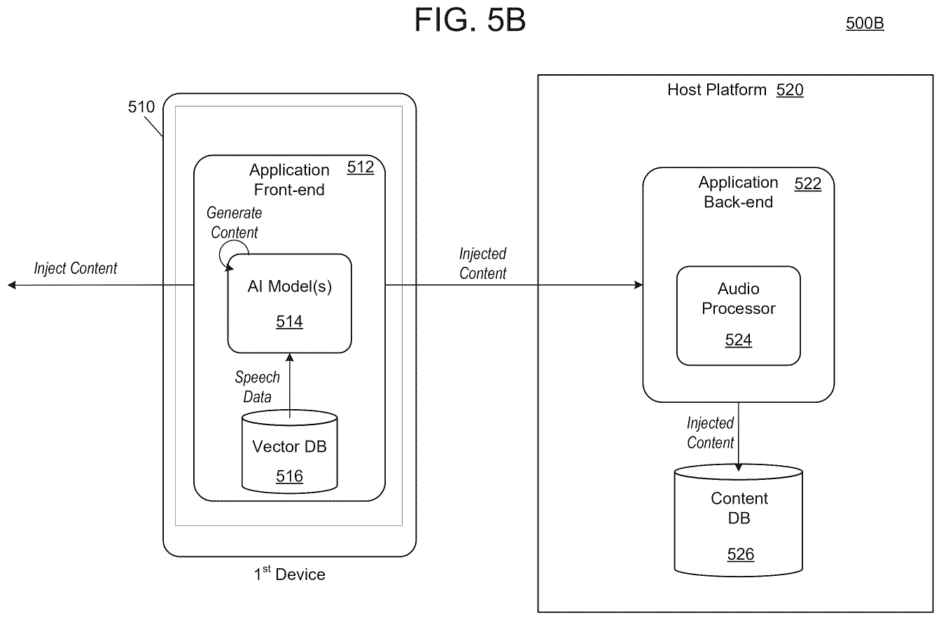

FIG. 5A illustrates a process 500A of analyzing audio from a communication session according to the examples and features of the instant solution. Referring to FIG. 5A, a first device 510 may be an example of a computing device 110 (see, for example, FIG. 1A) and may be participating in a communication session, and a host platform 520 may be an example of a host platform 120 or host platform 210 (see, for example, FIGS. 1A, 2A-2C) and hosts a software application through which the communication session may be conducted/hosted. The host platform 520 may host an application back-end 522 of the software application while the first device 510 may host an application front-end 512. The application front-end 512 may capture audio content (e.g., sound waves) from a microphone 511 installed on the first device 510.

In this example, the speech data/sound wave may be sent from the application front-end 512 to the application back-end 522. Here, the application back-end 522 may include an audio processor 524 which may be configured to analyze the speech data/sound from the communication session and detect occurrence of a pause in the conversation being conducted during the communication session. In response to detecting the pause, the application back-end 522 may invoke an AI model(s) 514 included in the application front-end 512. The invocation may request that the AI model(s) 514 generate conversation content to be injected into the conversation during the communication session and speech data from the conversation. Referring to FIG. 5A, the AI model(s) 514 may be an example of AI model 232 (see, for example, FIGS. 2A-2C), and the AI model(s) 514 may or may not be co-located with the first device 510.

FIG. 5B illustrates a process 500B of executing at least one AI model to generate conversation content according to the examples and features of the instant solution. Referring to FIG. 5B, the AI model(s) 514 may receive the call from the audio processor 524 and generate conversation content which may then be injected into the communication session (eg., by displaying the conversation content on a GUI of the application front-end 512, or the like. The AI model(s) 514 may include a vector DB 516 that can be queried quickly and used to obtain vectorized content such as previous call content, call scripts, etc. which are related to the speech data from the conversation, and generate content that may be related to the speech data from the conversation such that the conversation can continue without additional delay.

By bi-furcating the AI model(s) 514 and the audio processor 524 into the application front-end 512 and the application back-end 522, respectively, the system can operate quickly and almost in real-time enabling the system to quickly detect the pause and provide help to at least one of the users in the conversation. Furthermore, the application back-end can store the content injected into the communication session in a content DB 526 thereby preserving the generated content for subsequent retraining of the AI model(s) 514.

Referring to FIG. 5B, the AI model(s) 514 may be an example of AI model 232 (see, for example, FIGS. 2A-2C), and the AI model(s) 514 may or may not be co-located with the computing device. The vector DB 516 and content DB 526 may be examples of database 115 or database 214 (see, for example, FIGS. 1A, 2A-2C). The vector DB 516 and AI model(s) 514 may or may not be co-located with the first device 510. Host platform 520 may be an example of host platform 120 or host platform 210 (see, for example, FIGS. 1A, 2A-2C).

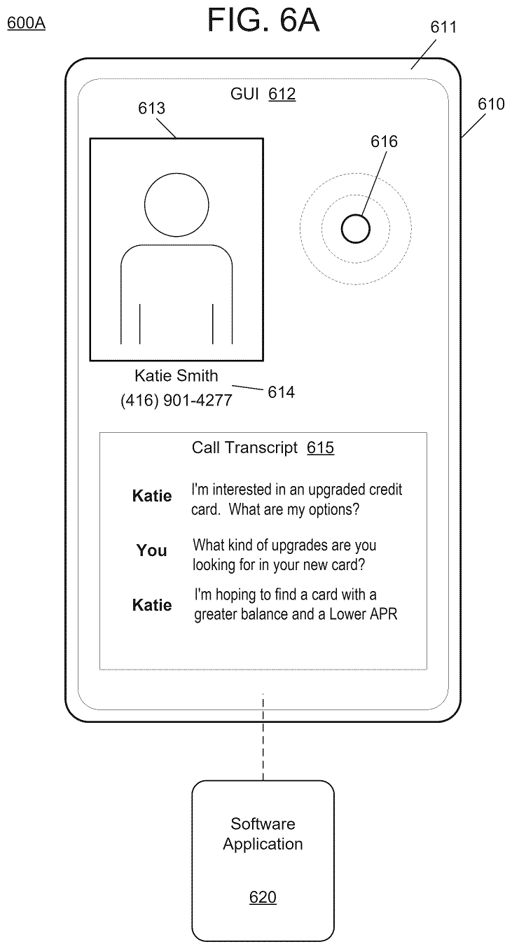

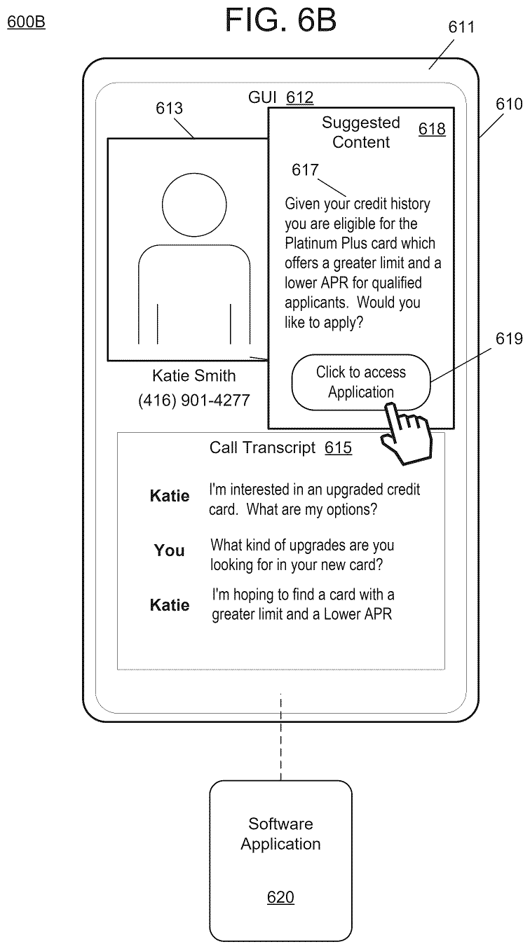

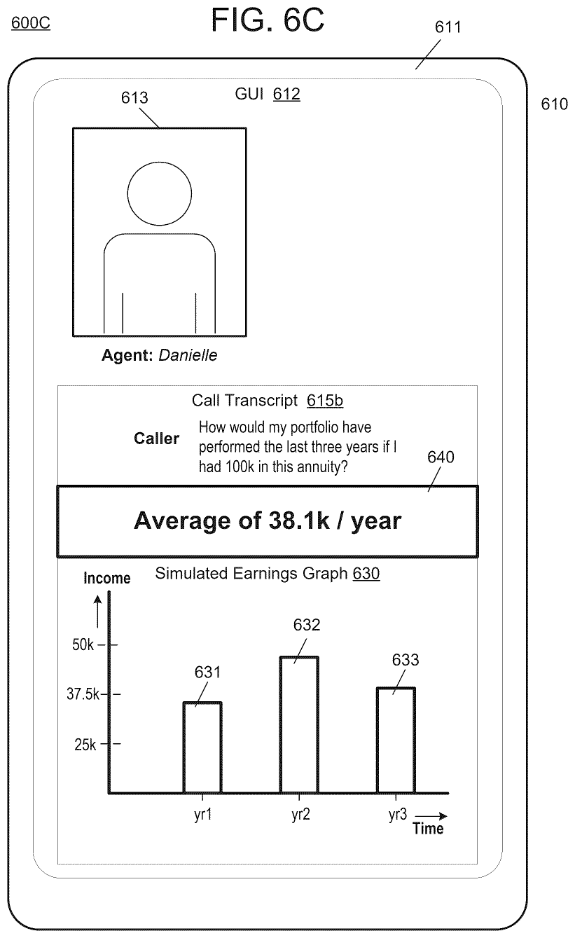

FIGS. 6A-6B illustrate a process of identifying an available pixel location on a display screen and outputting conversation content at the available pixel location according to the examples and features of the instant solution. For example, FIG. 6A illustrates a process 600A of identifying an available pixel location 616 within a GUI 612 of a software application 620 which may correspond to the software application shown in FIGS. 1A-1B, 2A-2C, 3, 4A-4C, 5A-5B, etc.

Referring to FIG. 6A, a communication session may be currently being conducted between a device 610 and another device (not shown) through the software application 620. Here, the software application 620 outputs the GUI 612 on a display device 611 of the device 610. The software application 620 may also output a visual depiction 613 of the other user with whom the participant may be speaking, attributes 614 of the other participant such as name, phone number, email, geographic location, etc., and a call transcript 615 of the call. The call transcript 615 may be updated in real-time by the software application 620 as additional audio may be captured by the software application 620 on either of the devices.

According to various examples and features of the instant solution, the software application 620 may analyze display pixels of the display device 611 for available space where additional content can be displayed without blocking or interfering with content already displayed on the display device 611. For example, the software application 620 may capture light data from the different pixels to determine which pixels contain image content that may be currently being displayed and which pixels do not. The software application 620 may use machine learning or artificial intelligence to detect the availability of each pixel, however, the examples and features of the instant solution are not limited thereto. For example, the software application 620 may attempt to identify a location on the display device 611 with enough pixels to place a display of content with a particular size. In this example, the software application 620 identifies the available pixel location 616 on the display device where enough pixels are available to fit a display image of a certain size.

FIG. 6B illustrates a process 600B of rendering image content at the available pixel location 616 on the display device 611 of the device 610. In some examples and features of the instant solution, the image content may be small enough to fit within the available space on the display device 611. The image content may be bigger than the available space and may be displayed in a manner that partially overlaps with other content already displayed on the display device 611, but without preventing the content therein from being partially viewed. In this example, the software application 620 displays a window 618 of suggested conversation content 617 at the available pixel location 616 on the display device 611. The suggested conversation content 617 may be conversation content that may be generated by at least one AI model described herein. In addition, the window 618 may include a button 619 that may be selected by a user to perform additional steps associated with the suggested conversation content 617.

In this example, the window 618 may be rendered on the display device 611 such that it partially overlaps content already displayed by the display device 611 such as the visual depiction 613 of the other participant. In some examples and features of the instant solution, the software application 620 may dynamically size the text format of the suggested conversation content 617 within the window 618 based on the size of the window 618 that may be used to display the suggested conversation content 617. A window may not be used to display the content, but rather, the content may be displayed within an existing element such as a dashboard. The conversation content may be output in the form of audio by a talking bot, etc.

FIG. 6C illustrates a process 600C of alerting the display content on the GUI 612 based on additional speech data from the communication session. According to various examples and features of the instant solution, the software application described herein may dynamically alter content that is generated by the at least one AI model and that is being rendered/output during a communication session. As an example, the alteration may include increasing a size of the content being displayed, changing a color of the content being displayed, moving the location of the content being displayed, increasing the number of pixels used to display the content, changing the content being displayed, and the like. The at least one AI model may also determine what format to display content, for example, whether it is to be displayed as text, a chart, a graph, a combination of formats, and the like.

In the example of FIG. 6C, the participant asks about how their portfolio would have looked the last three years with 100k invested in the high-performing annuity included in it. The additional utterance causes the call transcript 615 to be modified to include the most-recent utterance thereby generating a modified call transcript 615b. The at least one AI model may determine that the question can be answered by the at least one AI model and shown visually with alternate content on the display screen. In this case, the at least one AI model generates a new/different graph (e.g., estimated earnings graph 630), which shows what the participant would have earned over the last three years if they had invested in the annuity. In this example, the projected earnings graph 630 is a bar graph with bars 631, 632, and 633 representing forecasted income of the asset for three different periods of time. The at least one AI model also determines to display textual data 640 to more effectively communicate the content.

In this example, the at least one AI model determines to delete the previous display content (the earning graph 620) and replace it with the projected earnings graph 630 and the textual data 640 in its place/same location on the GUI 612. This process may be iteratively repeated throughout the communication session.

According to various examples and features of the instant solution, the at least one AI model described herein may be trained to generate conversation content (e.g., utterances, words, phrases, etc.) for output during a communication session based on historical call scripts of previous conversations, profile data of the participants of the previous conversations, and the like. Furthermore, the system described herein may retrain the at least one AI model to generate more accurate conversation content, for example, based on whether the conversation content suggested by the at least one AI model may be used during the communication session, based on user feedback, etc.

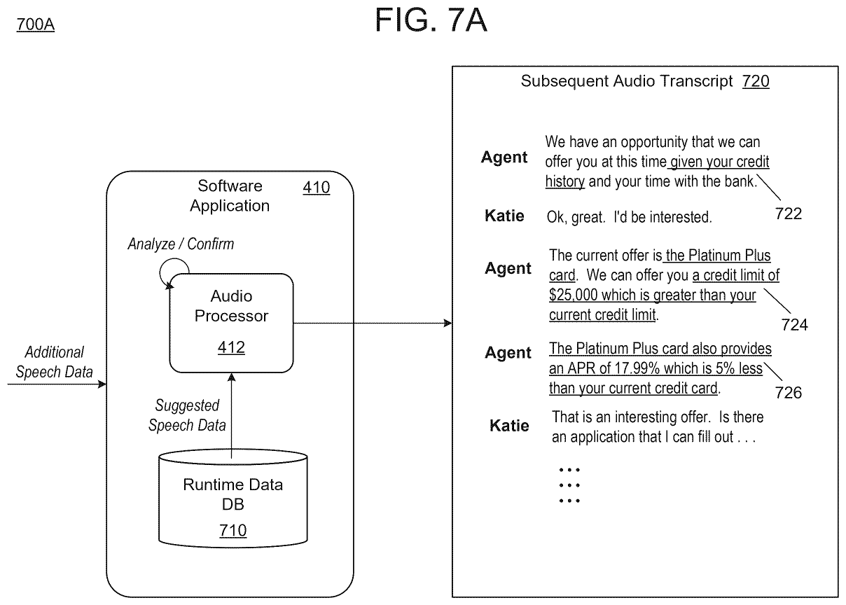

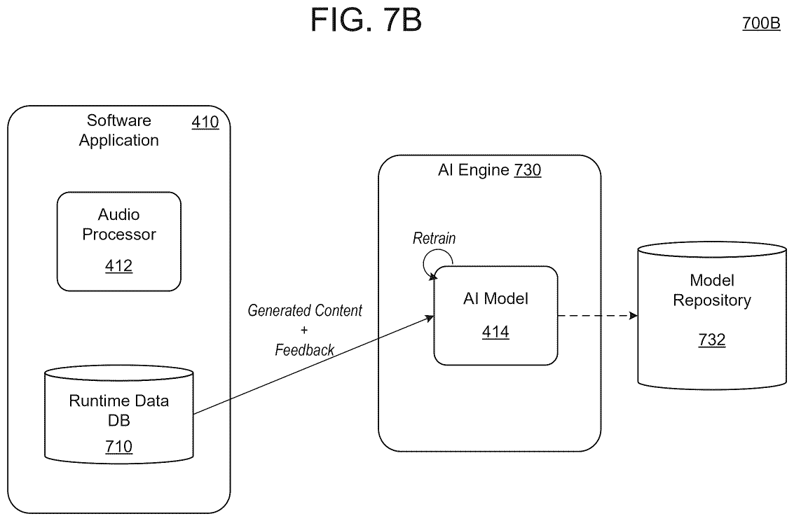

FIGS. 7A and 7B illustrate a process of receiving feedback conversation content generated by the at least one AI model and retraining the at least one AI model based on the feedback according to the examples and features of the instant solution. For example, FIG. 7A illustrates a process 700A of analyzing additional speech data from the communication session and verifying whether or not suggested content generated by the AI model has been used during the communication session. Referring to FIG. 7A, the software application 410 (corresponding to the software application 410 in FIGS. 4A-4C) may receive additional speech data from the communication session between the devices. The additional speech data may be received after the AI model 414 (corresponding to the AI model 414 in FIGS. 4B-4C) has generated conversation content and injected the conversation content into the communication session.

For example, the conversation content may include suggested speech to use during a call which may be displayed on a GUI of the software application 410. The suggested speech may be stored within a runtime data DB 710 and may be used to subsequently verify whether the suggested speech has been used. Here, the suggested speech data may be displayed on a device as a recommendation for the participant using the device. Furthermore, the software application 410 may continue to monitor the conversation to verify or otherwise confirm that the suggested speech data may be subsequently spoken by the participant during the conversation.

According to various examples and features of the instant solution, the audio processor 412 may analyze the speech data and generate a transcript 720 of the call. In addition, the audio processor 412 may analyze the transcript 720 to determine whether the suggested content output to the participant device may be included in the transcript 720. For example, the audio processor 412 may pull the suggested speech data from the runtime data DB 710 and compare it to the text content within the transcript 720 of the call. When the audio processor 412 detects a match, the audio processor 412 can confirm that the suggested speech data has been used. In this example, the audio processor 412 identifies conversation content 722, 724 and 726 which matches the suggested content generated by the AI model.

FIG. 7B illustrates a process 700B of retraining the AI model 414 based on the automatically detected feedback according to the examples and features of the instant solution. Referring to FIG. 7B, the feedback that may be automatically detected in the example of FIG. 7A may be used to retrain the AI model 414. For example, the feedback may include an identifier of the suggested content and an indication of whether the suggested content (e.g., speech data, etc.) has been verified/used during the communication session.

The feedback and the suggested content may be input to the AI model 414 via an AI engine 730. The AI engine 730 can cause the AI model 414 to execute on the feedback and the suggested content to further retrain the AI model 414. The result of the execution of the AI model 414 on the feedback and the generated content by the AI engine 730 may cause parameters of the AI model 414 to be adjusted thereby increasing the accuracy of the AI model 414 when generating subsequent content for this communication session and other communication sessions. The retrained AI model 414 may be stored within a model repository 732 and accessed for subsequent predictions. The model repository 732 may be an example of AI model registry 260 (see, for example, FIGS. 2A-2C), and the AI model 414 may be an example of AI model 232 (see, for example, FIGS. 2A-2C).

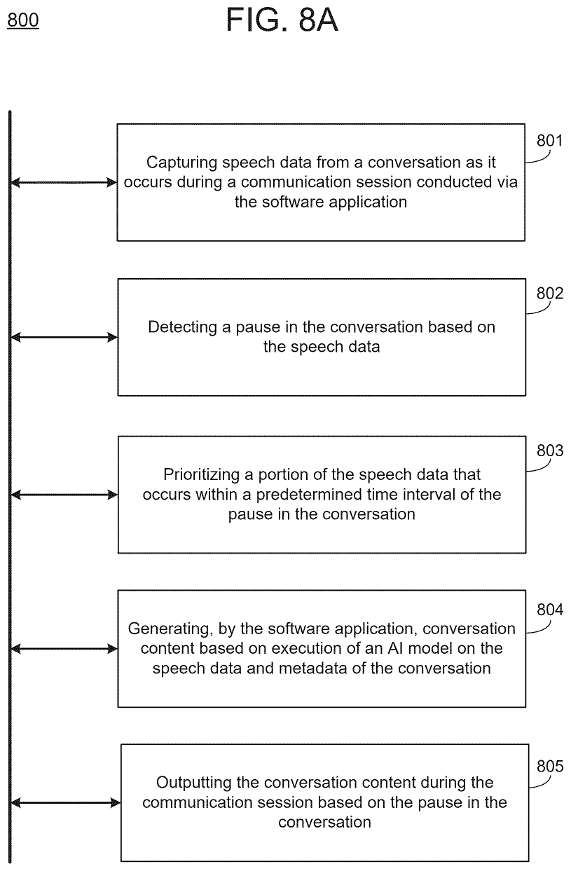

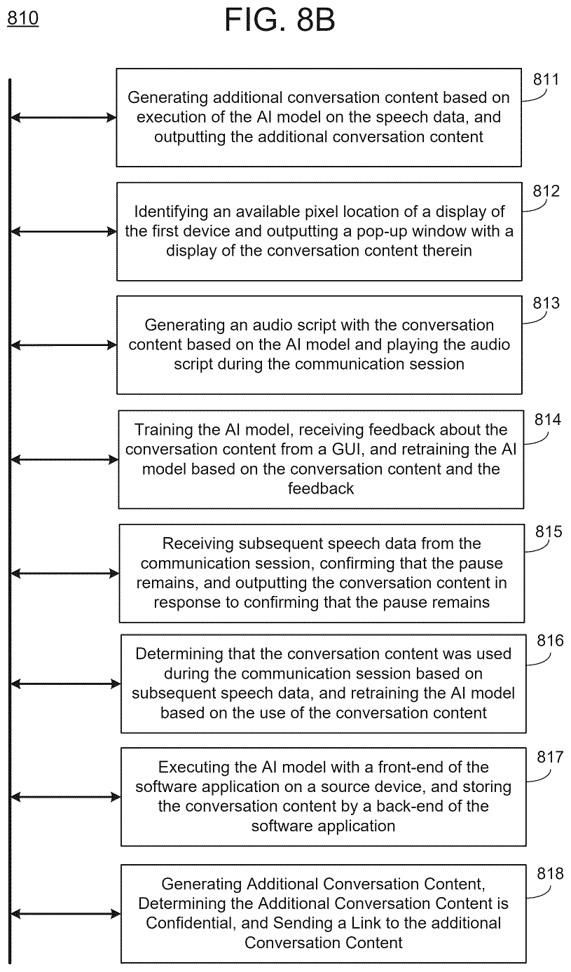

FIG. 8A illustrates a method 800 of generating and injecting conversation content into an ongoing communication session according to examples and features of the instant solution. As an example, the method 800 may be performed by a computing system, a software application, a server, a cloud platform, a combination of systems, and the like. Referring to FIG. 8A, in 801, the method may include capturing, by a software application, speech data from a conversation as it occurs during a communication session conducted via the software application between a first device and a second device. In 802, the method may include detecting, by the software application, a pause in the conversation based on the speech data captured from the conversation.

In 803, the method may include prioritizing, by the software application, a portion of the speech data that occurs within a predetermined time interval of the pause in the conversation. For example, the software application may prioritize a portion of the speech data that occurs within a predetermined time interval of the pause in the conversation. In 804, the method may include generating, by the software application, conversation content based on execution of an artificial intelligence (AI) model on the prioritized portion of the speech data. In 805, the method may include outputting, by the software application, the conversation content during the communication session based on the pause in the conversation.

FIG. 8B illustrates a method 810 of generating and injecting conversation content into an ongoing communication session according to examples and features of the instant solution. As an example, the method 810 may be performed by a computing system, a software application, a server, a cloud platform, a combination of systems, and the like. Referring to FIG. 8B, in 811, the method may include generating additional conversation content based on execution of the AI model on the speech data including the portion of the speech data that is prioritized and the conversation content, and outputting the additional conversation content into the communication session after outputting the conversation content. In 812, the method may include identifying an available pixel location of a display of the first device participating in the communication session based on content displayed on the display, and outputting a pop-up window with the conversation content displayed therein at the available pixel location of the display.

In 813, the method may include generating an audio script with the conversation content based on execution of the AI model and the outputting comprises playing the audio script during the communication session. In 814, the method may include training the AI model based on at least one of historical conversation content, historical call scripts, and historical profile data, receiving feedback about the conversation content from a graphical user interface (GUI) of the software application, and retraining the AI model based on the conversation content and the feedback about the conversation content.

In 815, the method may include receiving subsequent speech data from the communication session as it occurs and confirming that the pause remains based on the subsequent speech data, and outputting the conversation content during the communication session in response to confirming that the pause remains. In 816, the method may include receiving subsequent speech data from the conversation after outputting the conversation content, determining that the conversation content was used during the communication session based on the subsequent speech data, generating model feedback data that includes the conversation content and an indicator that the conversation content was used, and retraining the AI model based on the model feedback data.

In 817, the method may include executing the AI model with a front-end of the software application installed on a source device of the communication session, and outputting the conversation content by the front-end of the software application and storing the conversation content in a profile of the source device by a back-end of the software application. In 818, the method may include generating additional conversation content based on the execution of the AI model on the speech data including the portion of the speech data that is prioritized, determining that the additional conversation content is confidential content, and in response, sending a secure link to the additional conversation content to at least one device.

In some examples and features of the instant solution, the receiving may include receiving audio from the call while the call is in progress, converting the audio into text based on execution of a speech-to-text converter, and determining the focus of the call has shifted based on keywords identified within the text. In some examples and features of the instant solution, the identifying may include identifying a plurality of topics from a meeting summary stored in a software application, and the determining comprises comparing keywords in the received conversation data to keywords in the meeting summary. In some examples and features of the instant solution, the dynamically generating may include dynamically moving the display content of the first topic from its initial location to a different location on the user interface and presenting display content of the second topic on the user interface at the initial location of the display content of the first topic.

In some examples and features of the instant solution, the dynamically generating may include dynamically instantiating a new piece of content corresponding to the second topic on the user interface at a different location than the display content of the first topic on the user interface. In some examples and features of the instant solution, the identifying may include identifying a plurality of topics of interest to be discussed during the call and the displaying the dashboard comprises displaying a plurality of modules of content for the plurality of topics of interest, respectively, on the user interface simultaneously. In some examples and features of the instant solution, the dynamically generating may include rearranging the plurality of modules of content for the plurality of topics of interest based on execution of the GenAI model on the second topic.

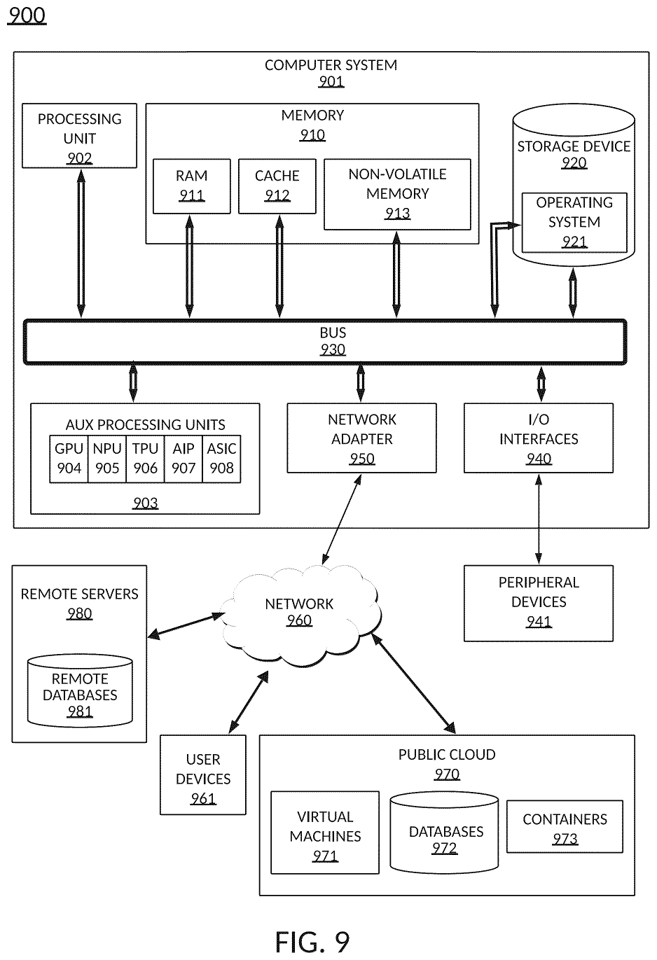

The examples and features of the instant solution may be implemented in at least one of the elements described or depicted herein, including for example, the elements described or depicted in FIG. 9. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 9 illustrates an example computer system architecture, which may represent or be integrated in any of the above-described components, etc.

FIG. 9 illustrates a computing environment according to the instant solution's example features, structures, or characteristics. FIG. 9 is not intended to suggest any limitation as to the scope of use or functionality of features, structures, or characteristics of the instant solution of the application described herein. Regardless, the computing environment 900 can be implemented to perform any of the functionalities described herein. In computing environment 900, there may be a computer system 901, operational within numerous other general-purpose or special-purpose computing system environments or configurations.

Computer system 901 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that may be capable of running a program, accessing a network 960 or querying a database. Depending upon the technology, the performance of a computer-implemented method may be distributed among multiple computers and among multiple locations. However, in this presentation of the computing environment 900, a detailed discussion may be focused on a single computer, specifically computer system 901, to keep the presentation as simple as possible.

Computer system 901 may be located in a cloud, even though it is not shown in a cloud in FIG. 9. On the other hand, computer system 901 may not be in a cloud except to any extent as may be affirmatively indicated. Computer system 901 may be described in the general context of computer system-executable instructions, such as program modules, executed by a computer system 901. Generally, program modules may include routines, programs, objects, components, logic, data structures, and so on that perform tasks or implement certain abstract data types. A s shown in FIG. 9, computer system 901 in computing environment 900 is shown in the form of a general-purpose computing device. The components of computer system 901 may include but are not limited to, at least one processor or processing unit 902, a system memory 910, and a bus 930 that couples various system components, including system memory 910 to processing unit 902.

Processing unit 902 includes at least one computer processor of any type now known or to be developed. The processing unit 902 may contain circuitry distributed over multiple integrated circuit chips. The processing unit 902 may also implement multiple processor threads and multiple processor cores. Cache 912 may be a memory that may be in the processor chip package(s) or located “off-chip,” as depicted in FIG. 9. Cache 912 may be typically used for data or code accessed by the threads or cores running on the processing unit 902. In some computing environments, processing unit 902 may be designed to work with qubits and perform quantum computing.

The Auxiliary Processing Units (A PU) 903 may contain at least one Graphics Processing Unit (GPU) 904, Neural Processing Unit (NPU) 905, Tensor Processing Unit (TPU) 906, AI Processor (AIP) 907, or other Application Specific Integrated Circuit (A SIC) 908. The at least one A PU 903 may contain circuitry distributed over multiple integrated circuit chips. The A PU 903 may implement multiple processor threads and multiple processor cores. The APU 903 may include at least one of onboard memory, onboard memory cache, and onboard instruction cache. The A PU may be communicatively coupled to the system bus 930 and configure to communicate with other system components, including a processing unit 902, system cache 912, RAM 911, non-volatile RAM 913, operating system 921, Network adapter 950, and Input/Output interfaces 940. In some computing environments, at least one of the at least one A PU 903 may be designed to work with qubits and perform quantum computing.

Memory 910 may be any volatile memory now known or to be developed in the future. Examples include dynamic random-access memory (RAM) 911 or static type RAM 911. Typically, the volatile memory may be characterized by random access, but this may not be the characterization unless affirmatively indicated. In computer system 901, memory 910 may be in a single package. It may be internal to computer system 901, but alternatively or additionally, the volatile memory may be distributed over multiple packages and/or located externally with respect to computer system 901. By way of example, memory 910 can be provided for reading from and writing to a non-removable, non-volatile magnetic media (shown as storage device 920, and typically called a “hard drive”). Memory 910 may include at least one program product having a set (e.g., at least one) of program modules configured to carry out the functions of various features, structures, or characteristics of the instant solution of the application. A typical computer system 901 may include cache 912, a specialized volatile memory generally faster than RAM 911 and generally located closer to the processing unit 902. Cache 912 stores frequently accessed data and instructions accessed by the processing unit 902 to speed up processing time. The computer system 901 may also include non-volatile memory 913 in the form of ROM, PROM, EEPROM, and flash memory. Non-volatile memory 913 often contains programming instructions for starting the computer, including the basic input/output system (BIOS) and information to start the operating system 921.

Computer system 901 may include a removable/non-removable, volatile/non-volatile computer storage device 920. For example, storage device 920 can be a non-removable, non-volatile magnetic media (not shown and typically called a “hard drive”). At least one data interface can connect it to the bus 930. In features, structures, or characteristics of the instant solution where computer system 901 has a large amount of storage (for example, where computer system 901 locally stores and manages a large database), then this storage may be provided by peripheral storage devices 920 designed for storing very large amounts of data, such as a storage area network (SAN) that may be shared by multiple, geographically distributed computers.

The operating system 921 may be software that manages computer system 901 hardware resources and provides common services for computer programs. Operating system 921 may take several forms, such as various known proprietary operating systems or open-source Portable Operating System Interface type operating systems that employ a kernel.

The bus 930 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 930 may be the signal conduction path that allows the various components of computer system 901 to communicate.

Computer system 901 may communicate with at least one peripheral device, 941, via an input/output (I/O) interface, 940. Such devices may include a keyboard, a pointing device, a display, etc.; at least one device that enables a user to interact with computer system 901; and/or any devices (e.g., network card, modem, etc.) that enable computer system 901 to communicate with at least one other computing device. Such communication can occur via I/O interface 940. As depicted, I/O interface 940 communicates with the other components of computer system 901 via bus 930.

Network adapter 950 enables the computer system 901 to connect and communicate with at least one network 960, such as a local area network (LAN) , a wide area network (WAN), and/or a public network (e.g., the Internet). It bridges the computer's internal bus 930 and the external network, exchanging data efficiently and reliably. The network adapter 950 may include hardware, such as modems or Wi-Fi signal transceivers, and software for packetizing and/or de-packetizing data for communication network transmission. Network adapter 950 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 960 may be any computer network that can receive and/or transmit data. Network 960 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 960 may be replaced and/or supplemented by LAN s designed to communicate data between devices in a local area, such as a Wi-Fi network. The network 960 typically includes computer hardware such as copper transmission cables, optical transmission fibers, wireless transmission, routers, firewalls, switches, gateway computers, edge servers, and network infrastructure known now or to be developed in the future. Computer system 901 connects to network 960 via network adapter 950 and bus 930.

User devices 961 are any computer systems used and controlled by an end user in connection with computer system 901. For example, in a hypothetical case where computer system 901 may be designed to provide a recommendation to an end user, this recommendation may typically be communicated from network adapter 950 of computer system 901 through network 960 to a user device 961, allowing user device 961 to display, or otherwise present, the recommendation to an end user. User devices can be a wide array, including personal computers, laptops, tablets, hand-held, mobile phones, etc.

A public cloud 970 may be an on-demand availability of computer system resources, including data storage and computing power, without direct active management by the user. Public clouds 970 are often distributed, with data centers in multiple locations for availability and performance. Computing resources on public clouds 970 are shared across multiple tenants through virtual computing environments comprising virtual machines 971, databases 972, containers 973, and other resources. A container 973 may be an isolated, lightweight software for running a software application on the host operating system 921. Containers 973 are built on top of the host operating system's kernel and contain software applications and some lightweight operating system A Pls and services. In contrast, virtual machine 971 may be a software layer with an operating system 921 and kernel. Virtual machines 971 are built on top of a hypervisor emulation layer designed to abstract a host computer's hardware from the operating software environment. Public clouds 970 generally offers databases 972, abstracting high-level database management activities. At least one element described or depicted in FIG. 9 can perform at least one of the actions, functionalities, or features described or depicted herein.

Remote servers 980 are any computers that serve at least some data and/or functionality over a network 960, for example, WAN, a virtual private network (VPN), a private cloud, or via the Internet to computer system 901. These networks 960 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 980 can also host remote databases 981, with the database located on one remote server 980 or distributed across multiple remote servers 980. Remote databases 981 are accessible from database client applications installed locally on the remote server 980, other remote servers 980, user devices 961, or computer system 901 across a network 960. An AI/ML model described or depicted here may reside fully or partially on any of the elements described or depicted in FIG. 9.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA) , a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms aligned with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution of at least one of a method, apparatus, computer-readable storage medium system, and other element, structure, component, or device as represented in the attached figures are not intended to limit the scope of the instant solution as claimed but are merely representative of aspects and examples of the instant solution. Any of the components described or depicted herein that perform a same or similar functionality may be a same or similar component. For example, different AI-related components that are described or depicted may be the same AI component.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

1. An apparatus comprising:
a memory; and
at least one processor communicatively coupled to the memory, the at least one processor configured to:
capture, by a software application, speech data from a conversation as it occurs during a communication session conducted via the software application between a first device and a second device;
detect, by the software application, a pause in the conversation based on the speech data captured from the conversation;
prioritize, by the software application, a portion of the speech data that occurs within a predetermined time interval of the pause in the conversation;
generate, by the software application, conversation content based on execution of an artificial intelligence (AI) model on the prioritized portion of the speech data; and
output, by the software application, the conversation content during the communication session based on the pause in the conversation.

2. The apparatus of claim 1, wherein the at least one processor is further configured to generate additional conversation content based on execution of the AI model on the speech data including the prioritized portion of the speech data and the conversation content, and output the additional conversation content into the communication session after outputting the conversation content.

3. The apparatus of claim 1, wherein the at least one processor is further configured to identify an available pixel location of a display of the first device participating in the communication session based on content displayed on the display, and output a pop-up window with the conversation content displayed therein at the available pixel location of the display.

4. The apparatus of claim 1, wherein the at least one processor is configured to generate an audio script with the conversation content based on execution of the AI model and play the audio script during the communication session.

5. The apparatus of claim 1, wherein the at least one processor is further configured to train the AI model based on at least one of historical conversation content, historical call scripts, and historical profile data, receive feedback about the conversation content from a graphical user interface (GUI) of the software application, and retrain the AI model based on the conversation content and the feedback about the conversation content.

6. The apparatus of claim 1, wherein the at least one processor is further configured to receive subsequent speech data from the communication session as it occurs, confirm that the pause remains based on the subsequent speech data, and output the conversation content during the communication session in response to confirmation that the pause remains, wherein an AI agent performs an action related to the output of the conversation content.

7. The apparatus of claim 1, wherein the at least one processor is further configured to receive subsequent speech data from the conversation after output of the conversation content, determine that the conversation content was used during the communication session based on the subsequent speech data, generate model feedback data that includes the conversation content and an indicator that the conversation content was used, and retrain the AI model based on the model feedback data.

8. The apparatus of claim 1, wherein the at least one processor is configured to execute the AI model with a front-end of the software application installed on a source device of the communication session, output the conversation content by the front-end of the software application, and store the conversation content in a profile of the source device by a back-end of the software application.

9. The apparatus of claim 1, wherein the at least one processor is further configured to generate additional conversation content based on the execution of the AI model on the speech data including the prioritized portion of the speech data, determine that the additional conversation content comprises confidential content, and in response, send a secure link to the additional conversation content to at least one device.

10. A method comprising:
capturing, by a software application, speech data from a conversation as it occurs during a communication session conducted via the software application between a first device and a second device;
detecting, by the software application, a pause in the conversation based on the speech data captured from the conversation;
prioritizing, by the software application, a portion of the speech data that occurs within a predetermined time interval of the pause in the conversation;
generating, by the software application, conversation content based on execution of an artificial intelligence (AI) model on the prioritized portion of the speech data; and
outputting, by the software application, the conversation content during the communication session based on the pause in the conversation.

11. The method of claim 10, further comprising generating additional conversation content based on execution of the AI model on the speech data including the prioritized portion of the speech data and the conversation content, and outputting the additional conversation content into the communication session after outputting the conversation content.

12. The method of claim 10, further comprising identifying an available pixel location of a display of the first device participating in the communication session based on content displayed on the display, wherein the outputting comprises outputting a pop-up window with the conversation content displayed therein at the available pixel location of the display.

13. The method of claim 10, wherein the generating comprises generating an audio script with the conversation content based on execution of the AI model and the outputting comprises playing the audio script during the communication session.

14. The method of claim 10, further comprising training the AI model based on at least one of historical conversation content, historical call scripts, and historical profile data, receiving feedback about the conversation content from a graphical user interface (GUI) of the software application, and retraining the AI model based on the conversation content and the feedback about the conversation content.

15. The method of claim 10, further comprising receiving subsequent speech data from the communication session as it occurs and confirming that the pause remains based on the subsequent speech data, wherein the outputting comprises outputting the conversation content during the communication session in response to confirming that the pause remains, wherein an AI agent performs an action related to the outputting of the conversation content.

16. The method of claim 10, further comprising receiving subsequent speech data from the conversation after outputting the conversation content, determining that the conversation content was used during the communication session based on the subsequent speech data, generating model feedback data that includes the conversation content and an indicator that the conversation content was used, and retraining the AI model based on the model feedback data.

17. The method of claim 10, wherein the generating the conversation content comprises executing the AI model with a front-end of the software application installed on a source device of the communication session, and the outputting comprises outputting the conversation content by the front-end of the software application and storing the conversation content in a profile of the source device by a back-end of the software application.

18. The method of claim 10, further comprising generating additional conversation content based on the execution of the AI model on the speech data including the prioritized portion of the speech data, determining that the additional conversation content comprises confidential content, and in response, sending a secure link to the additional conversation content to at least one device.

19. A computer-readable storage medium comprising instructions which when executed by a processor cause the processor to perform:
capturing, by a software application, speech data from a conversation as it occurs during a communication session conducted via the software application between a first device and a second device;
detecting, by the software application, a pause in the conversation based on the speech data captured from the conversation;
prioritizing, by the software application, a portion of the speech data that occurs within a predetermined time interval of the pause in the conversation;
generating, by the software application, conversation content based on execution of an artificial intelligence (AI) model on the prioritized portion of the speech data; and
outputting, by the software application, the conversation content during the communication session based on the pause in the conversation.

20. The computer-readable storage medium of claim 19, wherein the processor is further configured to perform receiving subsequent speech data from the communication session as it occurs and confirming that the pause remains based on the subsequent speech data, wherein the outputting comprises outputting the conversation content during the communication session in response to confirming that the pause remains, wherein an AI agent performs an action related to the outputting of the conversation content.
